(19) United States
(12) Patent Application Publication
(10) Pub. No.: US 2011/0040609 A1
(43) Pub. Date: Feb. 17, 2011

(54) COMPUTER-BASED CONSUMER/RETAILER MERCHANDIZING SYSTEM AND RELATED METHODOLOGY

(75) Inventors: Gary E. Hawkins, Skaneateles, NY (US); Sterling Hawkins, Skaneateles, NY (US)

Correspondence Address: Hiscock & Barclay, LLP, One Park Place, 300 South State Street, Syracuse, NY, 13202-2078, US

(73) Assignee: Hawkins Strategic, LLC, Skaneateles, NY (US)

(21) Appl. No.: 12/854,468

(22) Filed: Aug. 11, 2010

Related U.S. Application Data
(60) Provisional application No. 61/232,944, filed on Aug. 11, 2009.

(51) Int. Cl. G06Q 30/00; G06Q 10/00

(52) U.S. Cl. 705/14.25; 705/14.53; 705/1.1; 705/14.41

(57) ABSTRACT

A computer-based consumer/retailer/merchandizing system includes a consumer/purchasing module wherein all data relating to purchases made by at least one consumer of goods and services is stored in real-time irrespective as to whether purchases are made by way of brick and mortar stores or on-line purchases of goods and services. The purchase data is collected at the point of sale and transmitted to a database, which is identified by a unique code attributable to a consumer. Details relating to made purchases using the unique code can be reviewed by the consumer, these details being presented to via a web-based portal as an electronic summary of purchases. The system further permits at least one retailer or marketer to access purchase data and/or purchasing interests of the at least one consumer and permit target marketing of specific goods/services to the consumer based on the accessed information.

### CROSS REFERENCE TO RELATED APPLICATIONS

This is a non-provisional patent application that claims priority and benefit to U.S. provisional patent application Ser. No. 61/232,944 (Docket Number: 3030354 US01) that was filed on Aug. 11, 2009 and entitled “Computer-Based Consumer/Retailer Merchandizing System and Related Methodology”, the aforementioned (61/232,944) patent application is incorporated herein by reference in its entirety.

### FIELD OF THE INVENTION

This application relates generally to the field of consumer-related transactions and more specifically to a computer-based consumer/retailer/merchandizing system.

### BACKGROUND OF THE INVENTION

Transactions made by consumers can take on various modes for purposes of acquiring goods and services. For example, it is quite commonly known for consumers to acquire goods at so-called “brick and mortar” stores, such as supermarkets, department stores, and the like in which items are purchased according to various payment options (cash, credit card, debit card, etc).

Additionally, the increased prevalence of electronic or on-line shopping has created a viable and readily available alternative for consumers to obtain literally any good or service from the convenience of a personal computer (PC).

A product or service purchase is analogous to a keyword used in an online search; each are indicative of the consumer's interest. As such, there is a wealth of purchase data that is “locked up” in literally hundreds of thousands of U.S. retail stores. To that end, data on billions of individual product purchases is individually maintained in databases and point of sale systems at retail companies both in the United States and globally.

In North America, there were approximately 192 billion online searches made in 2007 alone collectively across all of the major known search engines (i.e., Google, Yahoo, etc.). Comparatively over 500 billion individual product purchases are made annually in the supermarket, drug store, and convenience retail store sectors alone.

It would be convenient to provide a system that consumers could readily access that would directly collect and collate all commercial transactions involving the consumer or the consumer's household.

It would further be convenient for retailers and marketing to utilize this transaction information in order to more effectively target specific goods and services by enabling the presentation of relevant advertising triggered by a keyword and further enabling search-based advertising to the world of product and service purchases.

### SUMMARY OF THE INVENTION

Therefore and according to a first aspect, there is provided a computer-based consumer/retailer/merchandizing system, said system comprising a consumer/purchasing module wherein all data relating to purchases made by at least one consumer of goods and services are stored in real-time irrespective as to whether purchases are made by way of brick and mortar stores or on-line purchases of goods and services, said data being collected at the point of sale and transmitted to a database, said purchase data being identified with a unique code attributable to a said consumer, means for enabling the at least one consumer to review details relating to purchases made by said at least one consumer using said unique code, said details being presented to said at least one consumer via a web-based portal, also referred to herein as a consumer portal or consumer web portal, as an electronic summary of purchases, and means for at least one retailer and marketer to access one of purchase data and purchasing interests of said at least one consumer and introducing at least one related product to said consumer based on said accessed information.

According to one version, the introducing means can include at least one marketing module that permits said at least one retailer and marketer to introduce targeted advertising related to at least one related product or service to said at least one consumer. Targeted advertising can be then introduced to said at least one consumer through said web-based (consumer) portal, in conjunction with said electronic summary of purchases. Targeted advertising can be produced in at least one version in the form of banner ads and/or specific retail advertising.

The web-based (consumer) portal can include means for at least one of managing and categorizing said electronic summary of purchases. The managing means can include, for example, means for exporting data from said electronic summary of purchases to money management software.

In one version, the at least one marketing module is provided as a kiosk in at least one store and is accessible to said at least one consumer. The at least one marketing module can introduces consumer marketing incentives, including coupons.

The web-based (consumer) portal can include means for selectively enabling a consumer to create a consumer specific profile. More specifically, the at least one retailer and marketer can selectively access portions of data in a consumer specific profile, enabling said retailer or marketer to provide targeted advertising to said consumer.

The “vehicle” enabling the present system is a consumer-facing personalized e-commerce (consumer) web portal at which the consumer can access their transaction history in the form of digital receipts that are generated from participating retail merchants with whom the consumer interacts. The digital receipt, and the individual product purchase detail, creates the opportunity for personalized, relevant advertising. In one example, a transaction receipt is created relative to a purchase, for example, at a brick and mortar store. The data is converted to a “digital receipt” that is viewable to the consumer on a (consumer) web portal. Included with the digital receipts are advertisements and promotions alongside the digital receipt, these advertisements being triggered by product purchases and/or other consumer preferences. “Clicking” on a presented advertisement activates an offer and subsequent purchase of the item, whether online or at a participating retail store, automatically triggers credit of the discount.

According to another aspect, a method is provided for providing at least one consumer with a summary of all purchases made irrespective of the goods or services purchased or the medium utilized for said purchases, said method comprising the steps of making a purchase of at least good or service at one of a brick and mortar store or through an on-line transaction wherein said purchase introduces an identification of said consumer and creates a unique code for said consumer, transmitting details relating to said purchase with said unique code to a database and storing said purchase details in a database; and wherein said consumer accesses said database via a web-based connection using said unique code, and in which the details of all purchases made by said consumer are accessible through said database.

The web-based connection can include a (consumer) portal that includes an electronic summary of purchases made by said consumer, including the step of at least one of managing and categorizing said electronic summary. In one embodiment, the managing step includes the step of cost managing said electronic summary, for example, including the step of exporting said electronic summary to money management software. In addition, content-based information can be added to the web-based connection.

The method can include the additional steps of creating a consumer profile that is stored in said database and accessing of said database, including said created profile, by at least one marketer and retailer. The method can also include the additional step of providing targeted advertising to consumers by means such as through said web-based connection or a retailers kiosk accessible to consumers using said unique code. This targeted advertising can include incentives such as manufacture coupons, including the step of redeeming the coupons electronically.

According to a preferred embodiment, the targeted advertising is based upon at least one sorting algorithm used in conjunction with purchase data of said at least one consumer.

The method can further include the step of providing reports to said at least one retailer and marketer relating to the effect of said targeted advertising. In a preferred version, a marketing portal enables entry of said targeted advertising.

An advantage provided by the present invention is that consumers can fully reconcile all of their commercial transactions for purposes of the consumer's interests and preferences as well as for budgeting/financial purposes. Digital receipts of the shopping “history” from all merchants enrolled in the service are collected and can be analyzed by the consumer.

Additionally, the consumer has the ability to opt-in using the herein described system to receive targeted promotions for savings on relevant products and services.

Moreover, the consumer also has the ability to export transaction data into financial management software applications. The herein described system therefore provides a means for effective budgeting. Still further, the system enables additional content to be presented along with promotions, for example, value-added content such as health and nutrition information, based on various consumer preferences.

From the marketer's point of view, the herein described system provides a new channel or resource in order to access consumers. The system further provides a vehicle in order to execute brand-level loyalty and reward programs direct to the consumer. In addition, the system creates a new world of search-driven advertising by making brick and mortar transaction data “searchable”.

Advantageously, the system creates personalized marketing capabilities that reduce or can substantially eliminate advertisement flyer costs while permitting the ability to create promotions to various and different customer segments.

The system creates personalized marketing capabilities that reduce or can substantially eliminate advertisement flyer costs while permitting the ability to create promotions to various and different customer segments: essentially an on-demand, personalized advertisement flyer that can be communicated digitally.

These and other features and advantages will be readily apparent from the following Detailed Description, which should be read in conjunction with the accompanying drawings.

### BRIEF DESCRIPTION OF THE DRAWINGS

FIG. 1 is a schematic block diagram of a computer-based commercial transaction management system that is made in accordance with an exemplary embodiment;

FIG. 2 is a user interface screenshot image of an exemplary consumer web portal for use in the management system of FIG. 1; and

FIG. 3 is user interface a screenshot image of an offer entry template for purposes of the management system shown in FIG. 1.

### DETAILED DESCRIPTION

The following relates to an exemplary embodiment of an electronic transaction management and marketing system and its related methodology. It will be readily apparent, from the discussion that follows, however that numerous modifications and variations can be introduced that are within the intended scope of the concepts, which are described herein.

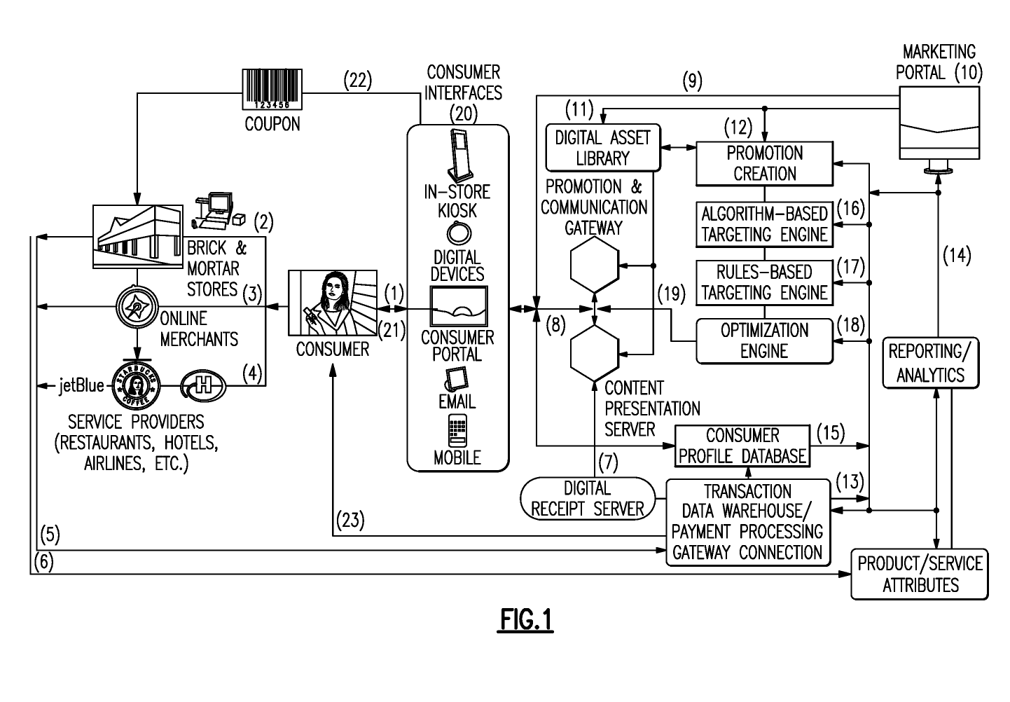

Referring to FIG. 1, a diagrammatic flow chart of the exemplary electronic transaction system is provided. The following system applies to consumers of literally any goods and/or services available presently, either via on-line procurement over the Internet or other available modes including but not limited to on-line merchants, service providers and so-called “brick and mortar” stores, such as department stores, grocers, hardware stores and the like. The following description relates sequentially to the steps as denoted in the diagrammatic FIG. 1. The system in brief involves subscribing to an electronic service that embodies the depicted system, hereinafter referred to as the “service”, and as described in greater detail below.

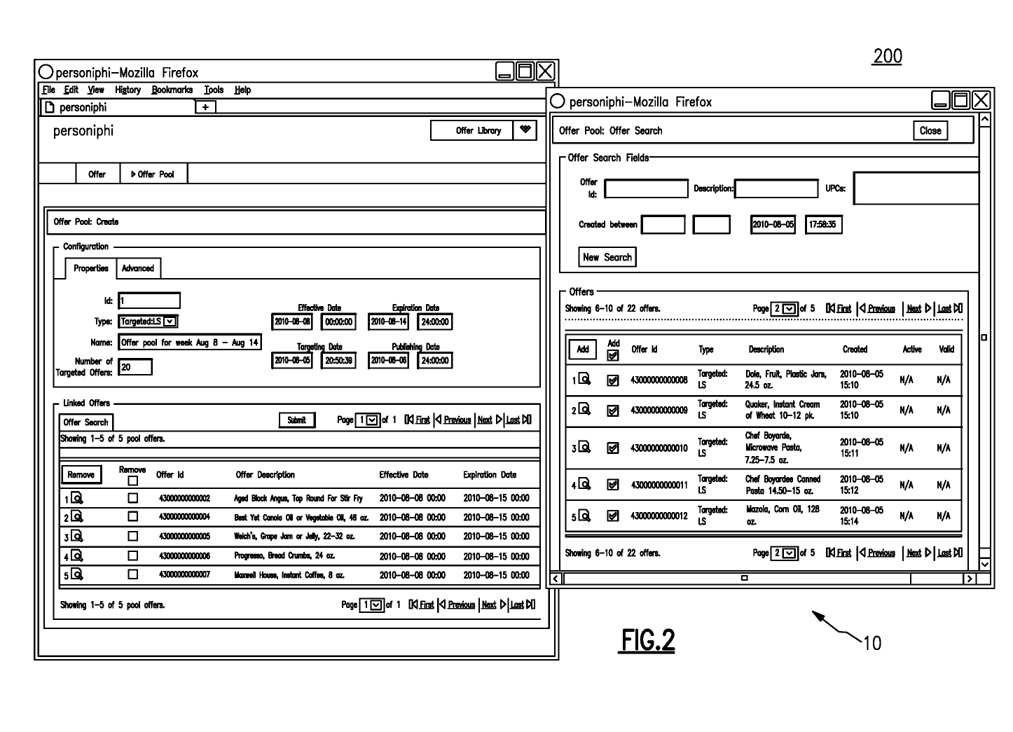

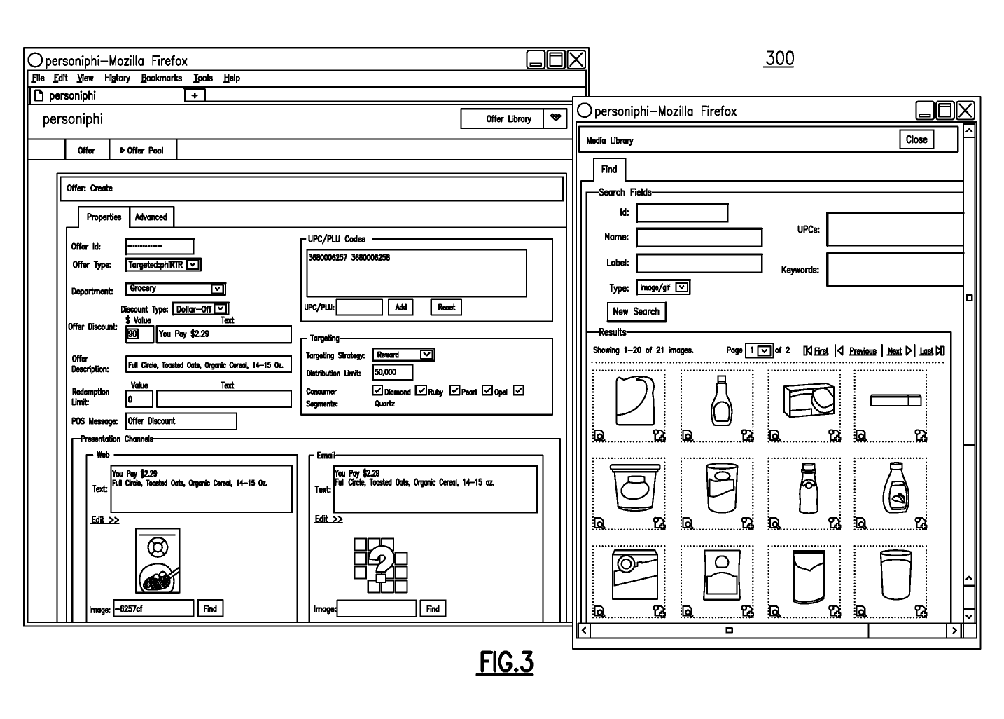

Therefore and according to step (1), consumers can initially enroll in the service according to various means. For example, subscription can be made via certain consumer interfaces (20) including the in-store kiosk, certain digital devices, consumer portal, or mobile, wherein a “Shopper Account” or “service account” is created. An account to the service can be established with limited information from the consumer, such as by creating a user name and password, as well as providing an e-mail address.” An account to the service can be established with limited information from the consumer, such as by creating a user name and password, as well as providing an e-mail address. An exemplary user interface screen shot image of a (consumer) web portal as described herein is provided in FIG. 2 as well as exemplary user interface screen shot image of a template presented for purposes of entry, according to FIG. 3.

Alternatively, a consumer may become enrolled in the service when the consumer enrolls in a retail merchant's loyalty program, either in a “brick and mortar” store or when joining the loyalty program via the Internet (online). In this case, the loyalty program subscription process includes the creation of a customer profile that includes the consumer's ID and corresponding customer information (e.g., name, household information, lifestyle attributes, etc) to be used at the merchant (for purposes of the merchant's loyalty program). At the same time, an account to the service will also be established for the consumer, notifying the consumer by e-mail, conventional mail or otherwise of the service and/or registering the retail merchant's Shopper ID with the consumer's existing account under the service.

Consumers can then register their Shopper ID information for any retail merchants that the consumer shops and that participate in the service network. For example, a consumer can provide their loyalty card number as well as a second identification factor for a supermarket that is frequented each week, wherein the supermarket is part of the service network.

While a primary form of shopper identification will be existing loyalty cards or identification means (e.g., key tags, cards, and the like) that are maintained by many retail merchants, other forms of identification that are supported by the particular retail merchant may also be registered. These forms of identification could include the use of the consumer's telephone number, a Shopper ID, an RFID card or chip that wirelessly transmits a Shopper's ID by radio frequency to the merchant's Point of Sale (POS) system, a biometric Shopper ID, (e.g., a fingerprint or retina scan), or other form of Shopper ID that creates a link between the shopper and their transaction; the “link” being electronically appended to the transaction by the merchant's POS system.

Consumers can also decide to create and maintain a more extensive profile that can be utilized by marketers in order to more effectively target promotional information on an individual basis to the consumer or to the consumer's household. This additional consumer profile information, for example, can be demographic in nature (e.g., geographic locale, number of persons in the household, household income) or other information that could be utilized for the purposes of marketing messages. Examples of such profile information can include radio stations frequently listened to by the consumer, current magazine subscriptions, vacation destinations, among others that provide an indication of potential likes and dislikes for purposes of targeting promotions and advertisements, as described in greater detail below. The consumer could further state specific brand references for certain products or services purchased (including particular food brands, drug store products, clothing brands and the like) and special needs (gluten-free, diabetic or kosher foods, etc.) as information for purposes of the extensive consumer profile.

According to step (2) as shown in the diagrammatic FIG. 1, the consumer conducts at least one transaction with at least one brick and mortar merchant that is enrolled in the “service network”; that is, those merchants that are part of the service. At checkout in these establishments, the consumer presents the Shopper ID that was registered with the service network for that particular merchant. The Shopper ID is then appended to an electronic transaction record, such as by scanning a barcode (such as found on retail merchant loyalty cards), inputting a numeric identification (such as a telephone number), or swiping a magnetic striped card such as a loyalty or payment card that is linked to the Shopper ID, or other method of electronically appending the Shopper ID to the consumer's transaction.

Alternatively, the consumer can present the Shopper ID they have been provided with during their enrollment into the retail merchant's loyalty program. (i.e., the consumer can use an ID issued as part of the service, or a pre-existing loyalty card the retailer already has in place.)

According to step (3), the consumer can alternatively make a purchase of at least one good or service by means of on-line shopping over the Internet. Transaction data produced when a consumer transacts with an online merchant can also be used in the herein described service/system. In this case, the consumer enters information during checkout to identify the consumer to the online transaction. For example, this identification could simply be a match of the consumer's name and address. Alternatively, the consumer could enter either a service account number, loyalty membership code, or any other suitable form of shopper information that enables identification of the consumer to the service. As in the case of the brick and mortar stores, all transaction data is similarly appended in this instance to the electronic transaction record.

In step (4), transactions through any service providers, whether on-line or in person, can also be utilized according to the presently described service and system. Service providers can include but are not limited to restaurants, hotels, airlines, car rentals, dry cleaners, recreational facilities (golf courses, ski resorts, etc) or providers of literally any other service. As in the preceding step, the consumer identifies himself or herself to the service provider wherein the Shopper ID is electronically appended to the transaction information. In this present case, Shopper ID can be, for example, membership information used by hotel or airline loyalty programs, car rental loyalty memberships, or other link.

As noted in the foregoing, and in each of steps (2), (3) or (4), the shopper identification is always appended to the electronic transaction record as well as identification and payment methods (in the instances such are made available). According to step (5), this transaction data is transferred electronically over a network to a transaction data warehouse. Transaction digital files may originate from either a store level or be sent in aggregate (i.e., data from many stores) from a merchant's headquarters store, in the case of brick and mortar merchants. Online merchants and service providers will in like fashion transfer transaction information to the transaction data warehouse. This transfer process may be via a real-time continuous network connection or via a batch transfer process in which information is electronically sent to the warehouse at discrete time intervals (e.g., once per day).

Transaction data can include, but is not limited to data that includes the store location or store identification, the date/time of the transaction, the Universal Price Code (UPC) number for each item purchased and/or description of the product or service purchased, the quantity of each item or service purchased, the selling price of each item or service, applicable discounts received, method of payment (e.g., cash, personal check, credit card, debit card, traveler's check), manufacturer's coupons redeemed, applicable sales tax paid for the item or service, total amount paid by the consumer for the transaction, and the Shopper ID code.

According to step (6), product and service (product/service) attributes of the consumers purchases are transferred to the transaction data warehouse. Typically, merchants, such as retail merchants, also maintain some form of categorization of their products and/or services for use in reporting and analysis. Examples would include a specific laundry detergent that is categorized as belonging to the laundry detergent category, or a hotel, which categorizes a room-service breakfast purchase as belonging to a “meals” category. Additional information attributes may also be separately maintained, for example, for a merchant's products and/or services provided. This categorization would typically include a full description of the product (i.e., name, package size, brand, etc) that is linked to the product's Universal Price Code (UPC), commonly encoded on a barcode on the label of the product's label), the tax status of a product or service, or other attributes. The product and service attributes are commonly stored as database elements in the data warehouse. They can be replicated, if needed, in a number of transactional systems for performance and scalability reasons.

This service and product information will be used in the creation of a digital receipt, as described below, and may also be electronically transferred to the merchant and/or marketers as described n greater detail below, wherein the product and service attribute information can be transferred by means of a batch (periodic) transfer or a real-time electronic network connection.

According to step (7), each electronic transaction sent to the transaction data warehouse is reconstituted in order to create a digital representation of the consumer's traditional paper receipt; that is, a digital receipt. This digital receipt may contain all information found typically on a “traditional” paper receipt, including, but not limited to the following information, namely, the store name, date and time of the transaction, description and quantity of the products and/or services purchased, discounts applied to the purchase, including coupons received, the total amount of the purchase due, and the form of payment. In addition to the foregoing, any product and service attribute data gathered according to the preceding step (6) may also be included in the creation of the herein digital receipt. Upon creation of the digital receipt, the receipt is transferred to a digital receipt server, where the receipt is stored in non-volatile memory, the server being configured to readily permit online access of the receipt by a subscribed consumer wishing to view a summary of the transaction data using their service account.

More specifically and according to step (8), the subscribed consumer can access the service by accessing any of the consumer interfaces (20) by signing into their account at the in-store kiosk, certain digital devices, consumer portal, or mobile (according to step (1) above), or by viewing their email.” Upon successful log-in to the service using their account, the consumer can view and manage their historical transaction data via the digital receipts through interaction with the digital receipt server. Transaction data can be managed and manipulated, for example, a consumer can categorize their purchases by type or retailer (e.g., all purchases from drug stores) or type of item (e.g., all snack food items). Additionally, the consumer may also rank transactions, for example, by date, merchant, transaction amount, payment method. It will be readily apparent that other forms of categorization and prioritization are possible.

Moreover, the service permits exportation of transactional data from the transaction data warehouse through the (consumer) web portal to other programs, for example, financial management software or other applications.

The consumer web portal is configured to optionally provide additional content relevant to the consumer, based upon the purchases and/or utilizing information contained in the consumer's account profile. This additional content can include information, for example, such as recipes (as linked to various food purchases), health and nutritional information (for example, as triggered by purchase of gluten-free or salt-free foods), or other relevant content and is controlled by a content presentation server, as connected to the digital receipt server and transaction data warehouse and consumer profile database.

According to step (8.5), consumer profile information, such as obtained from the account information or other is stored in a consumer profile database, at least portions of which are accessible to third parties such as retailers and marketers, as described in greater detail below.

According to step (9), the service may provide access to the digital receipts, some portion of the consumer profile data, and/or other content that is presented to the consumer via the consumer web portal to third parties through a marketing web portal. These third parties can include outside search firms such as Google, Yahoo, AOL, and others for purposes of generating and placing paid advertisements triggered by specific purchase information that is reflected on the digital receipts and/or consumer profile, as stored in each of the transaction data warehouse and consumer profile database, respectively. The above third parties would subscribe to the service and obtain a service account enabling access to the marketing service web portal.

In such a scenario, each search firm would utilize the information and apply their own specific algorithms for search purposes wherein the service would then facilitate posting of the search firm's specific content based thereupon via the consumer web portal to the service.

A similar marketing portal will be provided by the service according to this step to the retailer in order enable the targeting of retailer specific offers based on the transaction history at a particular location, e.g., supermarket creating offers for supermarket customers, etc. In a preferred version, the service would provide a certain base-level of targeting capability for the retailer for utilization if no other such means are available. As in the preceding, the service would facilitate posting of the retailer's specific content (web pages) to the service's portal that the subscribed consumer can access.

According to step (10), the service will enable relevant advertising and provide the capability for marketers to create and potentially place advertising on web pages that the consumer can access when interacting with the marketing service portal, such as viewing digital receipts or viewing other content. Such advertising can be equivalent to so-called “search” triggered ads on sites such as Google or Yahoo, wherein a product or service purchase becomes analogous to a keyword in a search. Additionally, marketers may make use of the information contained that is contained in the consumer profile module of the service database in the targeting of advertisements for those consumers who have created a profile and have also elected to receive such advertising.

For purposes of the preceding, a form of auction-based pricing model would be enabled through the marketing service portal, in order to permit marketers to bid on certain keywords pr presenting to presenting to consumers who meet certain profile characteristics. For purposes of the targeting and presentation of advertising, data from the service database (warehouse) and information provided through the web server can be used.

Digital assets, such as product or service images, rich media content, brand logos, and other advertising assets are stored in a digital asset library, according to step (11) of the herein depicted diagram. New and updated material can be added to the library at the marketer's discretion.

Marketing personnel can establish a service account and access the service marketing portal in order to create promotions, according to step (12), to targeted consumers. Promotions can be created to achieve corporate brand goals, taking into account digital assets available, consumer profile information and preferences, transaction log history and budgetary constraints.

Transaction data is imported from the transaction data warehouse into the promotion creation process, according to step (13) wherein detailed transaction data is utilized by the targeting engines (e.g., algorithm-based engine and/or the rules based targeting engine) for the purpose of targeting and/or triggering promotions and advertisements to the consumer. The digital asset library is also accessible for purposes of this process.

In one version and according to step (14), retailers can obtain either standard and/or ad-hoc reports and other analytics from the service marketing portal, as needed, in order to provide insights into consumer behavior. Standard reports will typically include information such as spending tiers, specific product promotion results, and consumer usage rates, among other suitable data. These reports would further include data such as customer lifecycle, customer category reporting and other segmentations. As to analytics, the retailer can also segment their relevant consumer population to further improve targeting processes. Demographics, purchase history and spending thresholds can also be factors that can be utilized from the marketing portal for purposes of segmentation. These segments can later be imported into the promotion building.

According to step (15), the consumer profile preferences that were created from the purchase history and/or created by the consumer and stored in the Consumer Profile Database are made available to the promotion creation and marketing targeting process. Information made available from this database can include but is not limited to household details, customer contact information (e.g., name, address, e-mail address, etc.), Shopper ID, retailer-specific identification method(s) (e.g., loyalty card number, phone number, biometric scan, etc), payment instruments (e.g., cash, check, credit card, debit card, etc.), communication channel preferences, specific food requests or requirements, and brand preferences. Alternatively or in conjunction with this data transfer, customer information can be imported from the retailer, including merchant-created segments provided consistently with a periodic feed. The inclusion of any customer profile data into the marketing process is based on-in from the specified consumer(s) or prior permission, in order that consumer privacy concerns are protected. To ensure safety of the customer data, multiple security solutions may be employed, such as multiple firewalls between system tiers, encryption at the database level, server level and encrypted communication between the server and client applications. (Specific architecture and encryption methods/algorithms can be embodiment-dependent).

Once created, promotions and/or content can be targeted using either a rules-based targeting engine (step (17)) or a algorithm-based rules engine (step (16)) or a combination of either of the above engines. In either case, historical transaction data and other data (e.g., customer segment, profile data, etc.) is utilized as necessary by the appropriate targeting engines for the purposes of targeting specific promotions or content to specific consumers based upon the information and direction provided by the marketer during the promotion creation process.

According to step (18), promotions and content are run through the appropriate targeting engine (see step (16) or (17)), wherein the resulting promotions and content are run through the appropriate optimization engine before being presented to individual consumers at the consumer portal along with other content.

Once the promotions and content have been run through the appropriate targeting engine, the digital promotions and/or digital content are then transmitted to a Promotion and Communication Gateway, according to step (19). As a promotion is released to the consumer portal or other consumer interface, the optimization engine used is utilized in order to effectively monitor success rates wherein the subsequent release of promotions to the current and other similarly situated consumers are modified as is needed. If appropriate, an alert can optionally be sent (to send the status updates multiple communications channels can be utilized; depending on the availability of certain channels and user preferences, the status updates can be displayed on one or more portal interfaces—web, mobile, interactive kiosk—or sent as email or SMS messages) to users in order to provide real time promotion feedback. Depending on the consumer's preferences and promotion restrictions, the Promotion and Communication Gateway is configured to be prepared for the push and/or pull of offers and the corresponding digital content through their respective channels.

In terms of communication and according to step (20), promotions and other digital content are staged and dispatched to various respective channels (consumer interfaces) at predetermined times. Based on consumer preferences and retailer sales cycles, this content may be staged for several days at a time before it is communicated to a specific channel(s) or before the content is effective in a real-time environment. In terms of consumer interfaces, an in store kiosk or on-line printer may be available as a decision point communication using the present service. Consumer-controlled channels (interfaces) for these purposes can include any digital device or channel, such as e-mail, mobile telephones and the consumer service portal.

According to step (21), a consumer can view each of the promotions that are specifically targeted by the service, retailers and marketers including any other content provided by the service by the content presentation server at their discretion. A consumer portal may be enabled to permit consumers to modify and sort offers according to explicitly set preferences or via a set of rules autonomously inferred from the consumer's previous behavior. After any communication has been viewed (activated) by the consumer over the portal, the offers are then made available to the consumer for their redemption.

If the merchant is not configured to accept a digital discount that is made available by the service to the consumer, or the consumer has opted for coupon discounts, a paper coupon or alternatively, a coupon code, is made available to the consumer, according to step (22). Once any coupons are scanned or entered at the point of purchase, the relevant discounts are applied to the transaction.

According to step (23), the vendor is electronically debited and the consumer is credited by the service. Applications running in the Transaction Data Warehouse record all discounts that have been delivered to each subscribed consumer as well as any credits that are still owed. Utilizing a unique identifier, the shopper specific credit information is transferred to a Payment Processing Gateway. The Payment Processing Gateway is interconnected to the Transaction Data Warehouse and is capable of delivering credit and debits to and from individual service accounts. During specified intervals, the Payment Processing Gateway is configured to debit vendor accounts for the appropriate service account. The amount would include: offer value, additional taxes (if applicable), as well as any service-related charges. Debited amounts would be caused to flow back into the payment processing gateway. The payment processing gateway delivers a credit to the consumer's specified service account. These credits can be made to any applicable payment method including bank credit cards, checking accounts or a private labeled store credit card. There may be associated fees associated with the transaction. The consumer receives notification of the credit to their service account on a regular (e.g., weekly) basis. Credits are itemized per offer that is credited and are also aggregated for easy access by the consumer.

Though each of the foregoing has been described in terms of an exemplary embodiment, it will be readily apparent that various modifications and variations are possible within the intended ambits of the invention and according to the following claims.

1. A computer-based consumer/retailer/merchandizing system, said system comprising:
a consumer/purchasing module wherein all data relating to purchases made by at least one consumer of goods and services are stored in real-time irrespective as to whether purchases are made by way of brick and mortar stores or on-line purchases of goods and services, said data being collected at the point of sale and transmitted to a database, said purchase data being identified with a unique code attributable to a said consumer;
means for enabling the at least one consumer to review details relating to purchases made by said at least one consumer using said unique code, said details being presented to said at least one consumer via a web-based portal as an electronic summary of purchases;
means for at least one retailer and marketer to access one of purchase data and purchasing interests of said at least one consumer and introducing at least one related product to said consumer based on said accessed information.

2. A system as recited in claim 1, wherein said introducing means includes at least one marketing module that permits said at least one retailer and marketer to introduce targeted advertising related to at least one related product or service to said at least one consumer.

3. A system as recited in claim 2, wherein targeted advertising can be introduced to said at least one consumer through said web-based portal, in conjunction with said electronic summary of purchases.

4. A system as recited in claim 2, wherein said advertising is produced in the form of banner ads.

5. A system as recited in claim 2, wherein said targeted advertising is produced in the form of specific retail advertising.

6. A system as recited in claim 1, wherein said web-based portal includes means for at least one of managing and categorizing said electronic summary of purchases.

7. A system as recited in claim 5, wherein said managing means includes means for exporting data from said electronic summary of purchases to money management software.

8. A system as recited in claim 2, wherein said at least one marketing module is provided as a kiosk in at least one store and is accessible to said at least one consumer.

9. A system as recited in claim 2, wherein said at least one marketing module introduces incentives, including coupons.

10. A system as recited in claim 1, wherein said web-based portal includes means for selectively enabling a consumer to create a consumer specific profile.

11. A system as recited in claim 10, wherein at least one retailer and marketer can selectively access portions of data in a consumer specific profile, enabling said retailer or marketer to provide targeted advertising to said consumer.

12. A method for providing at least one consumer with a summary of all purchases made irrespective of the goods or services purchased or the medium utilized for said purchases, said method comprising the steps of:
making a purchase of at least good or service at one of a brick and mortar store or through an on-line transaction wherein said purchase introduces an identification of said consumer and creates a unique code for said consumer;
transmitting details relating to said purchase with said unique code to a database and storing said purchase details in a database; and
wherein said consumer accesses said database via a web-based connection using said unique code, and in which the details of all purchases made by said consumer are accessible through said database.

13. A method as recited in claim 12, including the additional steps of creating a consumer profile that is stored in said database and accessing of said database, including said created profile, by at least one marketer and retailer

14. A method as recited in claim 13, including the additional step of providing targeted advertising to consumers.

15. A method as recited in claim 14, wherein targeted advertising is provided to said consumers through said web-based connection.

16. A method as recited in claim 14, wherein targeted advertising is provided to said consumers through a retailers kiosk accessible to consumers using said unique code.

17. A method as recited in claim 14, wherein said targeted advertising includes incentives.

18. A method as recited in claim 14, wherein said targeted advertising is based upon at least one sorting algorithm used in conjunction with purchase data of said at least one consumer.

19. A method as recited in claim 17, including the step of providing reports to said at least one retailer and marketer relating to the effect of said targeted advertising.

20. A method as recited in claim 17, wherein incentives include manufacturer coupons, including the step of redeeming said coupons electronically.

21. A method as recited in claim 14, including a marketing portal enabling entry of said targeted advertising.

22. A method as recited in claim 12, wherein said web-based connection is a portal that includes an electronic summary of purchases made by said consumer, including the step of at least one of managing and categorizing said electronic summary.

23. A method as recited in claim 22, wherein said managing step includes the step of cost managing said electronic summary.

24. A method as recited in claim 23, including the step of exporting said electronic summary to money management software.

25. A method as recited in claim 13, including the step of adding content-based information to said web-based connection.
